(19) United States
(12) Patent Application Publication
(10) Pub. No.: US 2006/0208579 A1
(43) Pub. Date: Sep. 21, 2006

(54) Parasitic power collection system for portable printer

(75) Inventor: Clive Paul Hohberger, Highland Park, IL (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: ZIH Corp.

(21) Appl. No.: 11/376,766

(22) Filed: Mar. 16, 2006

Related U.S. Application Data
(60) Provisional application No. 60/663,326, filed on Mar. 18, 2005.

(51) Int. Cl. H02K 41/00

(52) U.S. Cl. 310/12

(57) ABSTRACT

A parasitic power collection system is described that collects energy from the motion of the user of a wearable portable printer, or vehicle motion in the case of vehicle-mounted portable printer. It uses that collected energy to assist in recharging the battery of the portable printer and thus extend its operating life. Two embodiments are discussed which can be mounted inside the portable printer. Both embodiments use the motion a string of separated high magnetic flux NdFeB permanent magnets inside a set of induction coils to generate electricity. In the first embodiment, a line of magnets collects motion by acting as an oscillating pendulum captured in tube wound with induction coils. In the second embodiment, the magnets are arranged as a ring rotor floating inside a set of toroidal induction coils to generate electricity as the rotor moves in reaction to body or vehicle motion.

### CROSS-REFERENCE TO RELATED APPLICATIONS

This application claims priority from of U.S. Provisional Application No. 60/663,326, filed Mar. 18, 2005, entitled PARASITIC POWER COLLECTION SYSTEM FOR PORTABLE PRINTER, the contents of which are incorporated herein by reference.

### BACKGROUND OF THE INVENTION

1. Field of the Invention

The present invention relates generally to electrical power sources and more particularly to parasitic power sources for use in mobile and/or portable devices.

2. Description of Related Art

Power generation through directed human motion dates from prehistoric times. For example, hand crank, bow and pedal systems have been used to draw water, operate lathes, fans, open canal locks, pump air for forges and power bicycles.

Parasitic power collection seeks to inconspicuously derive power from either normal human or vehicle motion without deliberate action. The classic example is the self-winding wristwatch, which harvests arm motion associated with normal activity yet creates so little motion resistance as to be effectively invisible. Alternatively, parasitic power collection systems can harvest ambient sources of energy such as ambient light as in solar-powered calculators, or harvest ambient heat or electromagnetic energy as do passive RFID transponders. See Paradiso and Starner [1] for some examples and discussion.

Kendall [2] at the MIT Media Lab observed in a 1998 thesis that a person walking quickly can generate up to 67 watts of power because of the large dynamic forces generated. He further observed that collection of up to 10% of this (up to 7 watts) could be performed through shoe-mounted devices without little or no discomfort to the walker. Many children's shoes now collect a minute amount of power through piezoelectric transducers from the heel-strike motion during walking, and use it to operate decorative lights.

Electromagnetic power conversion devices have much higher useable energy conversion from motion than piezoelectrics, particularly with the advent of the high-flux density rare earth permanent magnets such as those formulated from samarium-cobalt (SmCo; typically 8,000+ gauss) and neodymium-iron-boron (NdFeB; typically 12,000+ gauss).

As is known, a major concern with most mobile and/or portable devices is the ability to provide a reliable portable power source for such devices. Most devices use battery power for this purpose. While battery power is typically reliable, it does have significant drawbacks. Specifically, batteries generally have a limited operating life. They must be either periodically replaced or recharged, which is inconvenient and may possibly remove the device from operation at a critical time.

The inconvenience with battery use as a singular power source is of particular concern for mobile and/or portable devices that require high peak currents for operation. For example, thermal printers use high current pulses to heat the heating elements of the print to print on a media. This creates a current use profile that includes low current use periods where the printer is idle with high current peaks during printing. These high current peak requirements typically require the use of specifically designed batteries. Further, the batteries typically require more frequent recharging or replacement. As such, systems and methods that extend battery charge life are desired.

### BRIEF SUMMARY OF THE INVENTION

The focus of the present invention is on use of parasitic power collection systems and methods that use normal human or vehicle motion as a source of energy. An excellent example is a rental car lot attendant. The attendant moves around continually, checking in cars. Actual time printing receipts is on the order of 1% of their time. A parasitic power generation system could be implemented in the printer to harvest energy from the attendant's motion and recharge the printer battery during the non-printing times.

Ideally, this parasitic power would be collected by subsystems mounted on or within a portable printer to directly recharge the battery, and not as a device connected to a shoe or other object. In typical embodiments, the use of parasitic power will be as a supplemental rather than a primary source of charge for the battery and used to extend battery-operating life. However, it is contemplated that the parasitic power source of the invention could be used as a primary power source.

A parasitic power collection system is described that collects energy from the motion of the user of a wearable portable device such as a printer, or vehicle motion in the case of vehicle-mounted portable device. The systems and methods use the collected energy to assist in recharging the battery of the portable printer and thus extend its operating life. Two embodiments are discussed which can be mounted inside the portable printer. Both embodiments use the motion a string of separated high magnetic flux NdFeB permanent magnets inside a set of induction coils to generate electricity. In the first embodiment, a line of magnets collects motion by acting as an oscillating pendulum captured in tube wound with induction coils. In the second embodiment, the magnets are arranged as a ring rotor floating inside a set of toroidal induction coils to generate electricity as the rotor moves in reaction to body or vehicle motion.

While two specific embodiments are illustrated, it is understood that the invention is not limited to these embodiments. The present invention is contemplated to cover any use of parasitic power in a portable printer.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a perspective view of typical portable printer in which the systems and methods of the present invention may be implemented;

FIG. 2 is schematic diagram of the electrical system for a typical portable printer in which the systems and methods of the present invention may be implemented;

FIG. 3 illustrates a typical magnetic string that may be used by the systems and methods of the present invention according to one or more embodiments;

FIG. 4 is a graph illustrating the magnetic flux density B(x) along a short section the path x taken by an individual magnet of length s and cross-section A of the magnetic string of FIG. 3, with the B axis oriented along the cylindrical axis, so that the flux density is the specified +B₀ at x=−0.5 s and −B₀ at x=−0.5 s, corresponding to the cylinder caps;

FIG. 5 is a graph illustrating the magnetic flux density B(x) as a function of x for a long magnet string 30 as comprised in FIG. 3;

FIG. 6 illustrates one embodiment of a parasitic power source of the present invention, in which emf is generated as the magnetic string of FIG. 3 moves laterally along a housing relative to a plurality of coils;

FIG. 7 is a graph of the emf generated by the parasitic power supply illustrated in FIG. 6;

FIGS. 8a and 8b illustrate alternative electrical configurations of the coils of the parasitic power source of FIG. 6; and

FIG. 9 illustrates one embodiment of a parasitic power source of the present invention, in which emf is generated as the magnetic string rotates in the housing relative to a plurality of coils.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

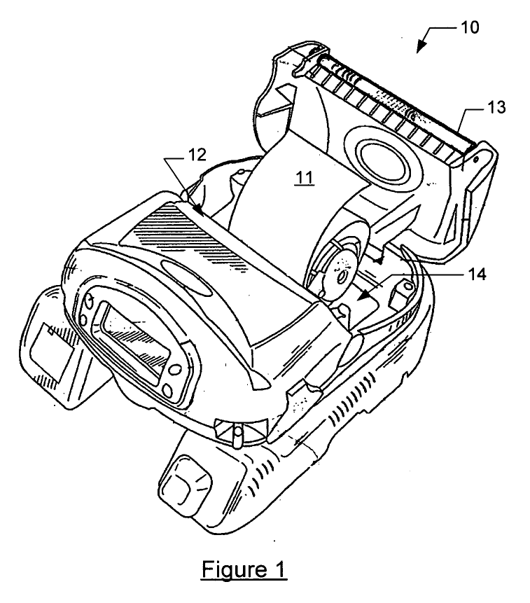

The parasitic power collections systems and methods discussed herein are contemplated for use in any mobile and/or portable device. The systems and methods are contemplated for particular applicability in portable printers. FIG. 1 illustrates a typical portable printer. As illustrated, the printer 10 includes a printing mechanism comprising a print head 12 and a platen 13 for moving media 11 past the print head. The media is typically located in a media housing 14, with a leading edge fed between the platen and print head. The print head contains a plurality of heating elements, not shown. The heating elements are selectively activated to either transfer ink from a ribbon to the media or to selectively activate heat sensitive media to thereby create text and images on the media. The printing mechanism includes various motor drives for moving the media and/or ribbon. Further, the printing mechanism includes various electronics for receiving and formatting images and text and controlling the print head to perform printing. Further, the portable printer may include various other electronics for displaying information to user, remote data communication systems, such as wireless systems (e.g., WiFi, 802.11, BLUETOOTH™, infrared, wires), scanners, such as RFID readers/encoders, bar code scanners, magnetic strip reader/encoders, etc. All of these various electronic systems of the printer can benefit from the systems and method of the present invention.

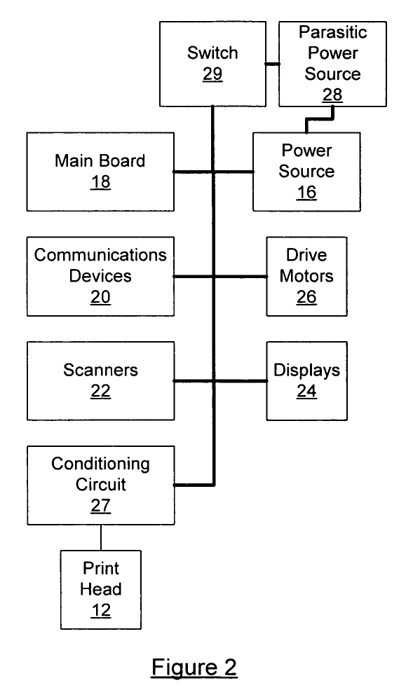

FIG. 2 illustrates a simplified diagram of electrical system of a typical portable printer. As illustrated, the printer typically includes a power source 16 in the form of a battery pack and/or power cord. Power from power source is typically provided via a power bus or series of wires to the various systems in the printer, such as the main board 18, which includes the main processor, communication devices 20, such as WiFi and BLUETOOTH™ systems, scanners 22, such as RFID readers/encoders, bar code scanners, magnetic strip reader/encoders, one more displays 24, various drive motor systems 26, etc. Power is either directly applied to the print head 12 or supplied via a conditioning circuit 27.

As generally illustrated, the systems and methods of the present invention may provide a second power source 28 that can either replace the power source 16 via switches 29 or boost or charge the power source 16 through direct connection to the power source.

It must be understood that the systems and methods of the present invention can be used with an device that experience motion or vibration that is of a magnitude to generate power in the parasitic power source. The term “mobile” or “portable” is typically used to refer to the types of devices in which the systems may be implemented. These terms are not meant to be limiting. Devices that can be readily moved or worn by a user are contemplated, as well as systems in movable vehicles, such as automobiles.

FIG. 3 illustrates one example of a parasitic source as contemplated by the present invention. In FIG. 3, a magnet string 30 comprising high flux-density NdFeB cylindrical magnets 32a-32d, with their poles at the cylinder caps as shown by 36, bonded with equal size, nonmagnetic separators 34a-34c. The cross-section of the magnets 32 is A and the length of both the magnets and separators 34 is s.

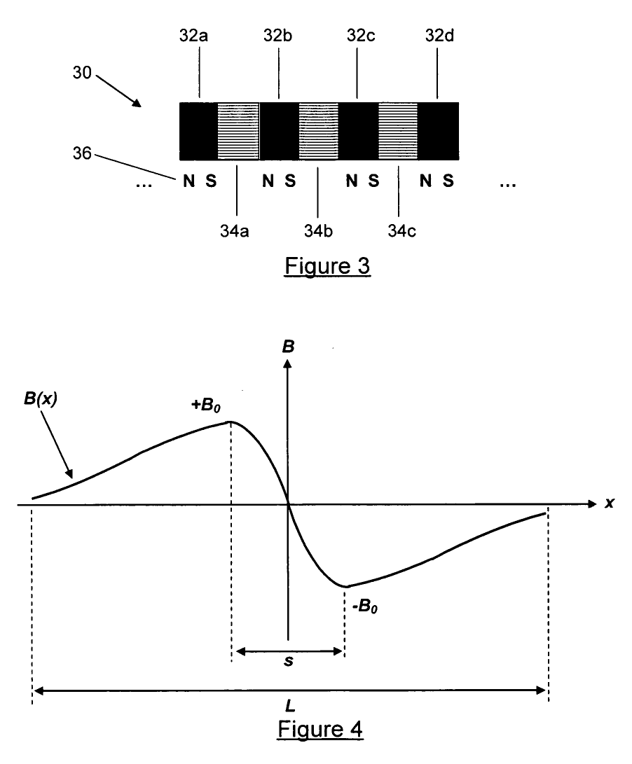

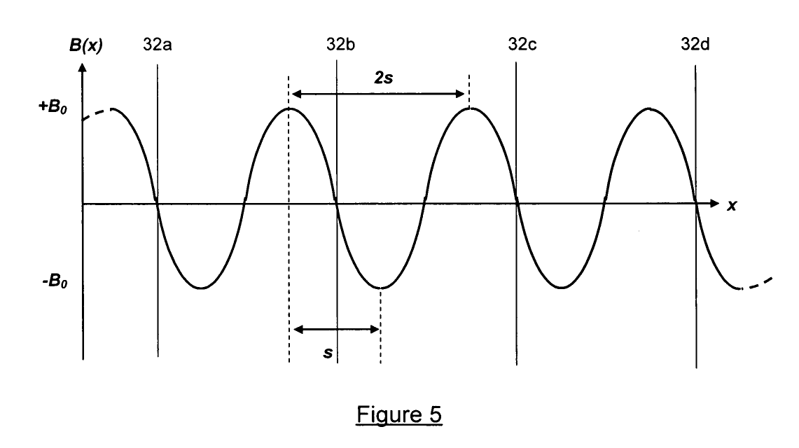

FIG. 4 shows a graph of the magnetic flux density B(x) along a short section the path x taken by an individual magnet of length s and cross-section A, with the B axis oriented along the cylindrical axis, so that the flux density is the specified +B₀ at x=−0.5 s and −B₀ at x=−0.5 s, corresponding to the cylinder caps. The magnetic flux extends out in both directions for some effective distance L, until the flux density is negligible. When the permanent magnet 32 is moved through an axial coil of length L, each turn of the coil has some emf induced in it, depending on the magnet flux density B(x) at the turns located at each position x in the coil.

A crude but adequately descriptive mathematical model can be constructed. Assume a uniform coil of length s. For each magnet at position x within the region of length L, the induced emf e(x) is given by Faraday's Law, where Φ(x) is the magnet flux passing through the coil. Assume a coil with constant cross-section A at point x, and that the magnet is moving at velocity V. Then

$$e ( x ) = \frac{ⅆ Φ ( x )}{ⅆ t} = A \frac{ⅆ B ( x )}{ⅆ t} = A \frac{ⅆ B ( x )}{ⅆ t} \frac{ⅆ x}{ⅆ t} = AV \frac{ⅆ B ( x )}{ⅆ x} . \qquad Equation 1$$

Let n represent the number of turns per unit length, assumed constant across the entire coil. The total induced emf, E is just found by integrating over all coil turns in the region from x=−s/2 to x=+s/2,

$$E = {\int }_{- s / 2}^{+ s / 2} ne ( x ) ⅆ x = {\int }_{- s / 2}^{+ s / 2} {nAV}_{0} B ( x ) ⅆ x . \qquad Equation 2$$

FIG. 5 shows the magnetic flux density B(x) as a function of x for a long magnet string 30 as comprised in FIG. 3. The flux density at the ends trails off in a manner similar to that shown in FIG. 4. In the interior of the string, especially in a long magnet string, the magnetic flux density B(x) behaves as periodic function of x, with a primary periodicity of 2 s, the length of each magnet 32 plus its attached spacer 34. The axial length of each N-turn coil is s.

Following Wylie [3], this or any other periodic function shown in FIG. 5 may be modeled using a Fourier cosine series to describe the magnetic field strength over an interval of length 2 s:

$$B ( x ) = {b}_{0} + {\sum }_{n = 1}^{∞} {b}_{n} cos [ \frac{n π x}{2 s} - {ϕ}_{n} ] . \qquad Equation 3$$

where the {bᵢ} in MKS units have the dimensions of Teslas (1 Tesla is equal to 10,000 gauss).

At x=0, 2 s, 4 s, . . . the sum of all terms is equal to B₀, and at x=s, 3 s, 5 s, . . . the sum of all terms is equal to −B₀. The bₒ term may be interpreted as the Earth's ambient magnetic field, on the order of 5 gauss, which here is negligible compared with Bₒ, here about 12,000 gauss.

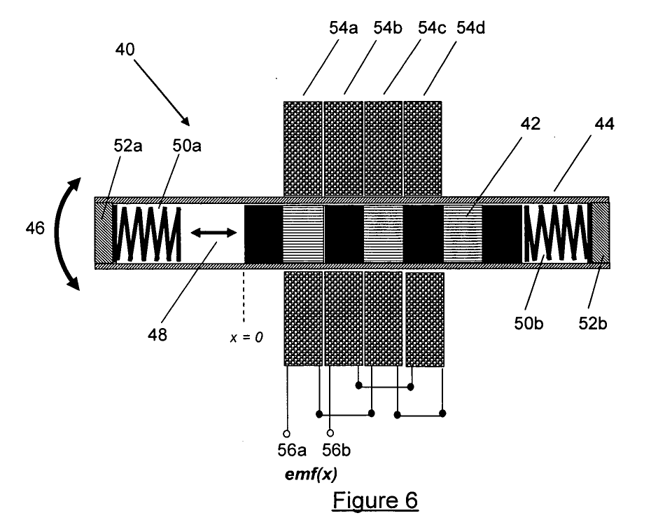

FIG. 6 illustrates one embodiment of a parasitic power source. A parasitic power collector 40 is mounted inside a portable printer (not shown) that is either worn on a person or attached to a vehicle. The collector 40 is formed using a magnet string 42 comprised as in FIG. 3, with the magnet string 42 free to slide as a unit in tube 44. When the portable printer moves about due to normal work motion, accelerations 46 causes the magnet string 30 to slide back and forth 48 in the tube 44. At the end of its travel, the magnet string 42 compresses either spring 50a or 50b against fixed end caps 52a or 52b respectively. The spring constant of the springs 50 is adjusted so that the spring is typically about 60% compressed when the tube 44 is vertical. When compressed, each spring 50a or 50b stores energy from the motion and releases it to accelerate the magnet string 42 when the orientation of the tube is changed. The added velocity increases the emf produced, as demonstrated in Equation 1 above. The system should preferably be mechanically resonant at normal walking speeds.

In the embodiment shown in FIG. 6, there are 4 coils 42a-42d, each wound in the same direction and with a like number of turns, N with approximately constant cross-sectional area, A. Through Faraday's Law of Induction in Equation 1, an electromotive force (emf) is induced across the coils 54a-54d by the changes in the magnetic field strength caused by motion of the magnet string 40 at velocity V. The emf induced in each N-turn coil is given by:

$${e}_{N} ( x ) = N \frac{ⅆ Φ ( x )}{ⅆ t} = NAV \frac{ⅆ B ( x )}{ⅆ x} . \qquad Equation 4$$

Differentiating Equation 3 for B(x),

$$\frac{ⅆ B ( x )}{ⅆ x} = \frac{ⅆ}{ⅆ x} [ {b}_{0} {\sum }_{n = 1}^{∞} {b}_{n} cos [ \frac{n π x}{2 s} - {ϕ}_{n} ] ] \\ \frac{ⅆ B ( x )}{ⅆ x} = - \frac{π}{2 s} {\sum }_{n = 1}^{∞} {nb}_{n} sin [ \frac{n π x}{2 s} - {ϕ}_{n} ] . \qquad Equation 5$$

Substituting in Equation 4,the emf induced in each coil when the magnet string is moving at velocity V is:

$${e}_{N} ( x ) = - \frac{π NAV}{2 s} {\sum }_{n = 1}^{∞} {nb}_{n} sin [ \frac{n π x}{2 s} - {ϕ}_{n} ] . \qquad Equation 6$$

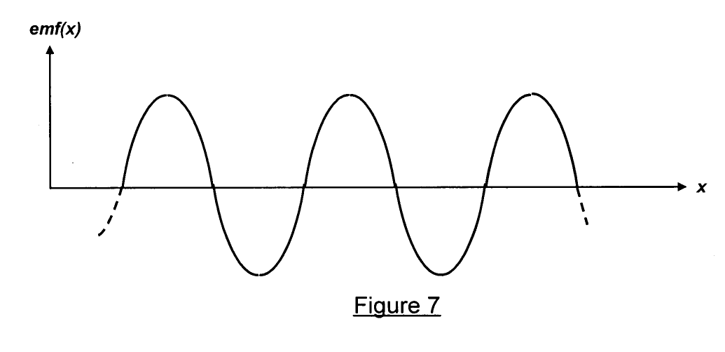

Therefore, the induced emf in each coil of width s is also a periodic function as shown in Equation 6 and FIG. 7, and is 90° out of phase with respect to the B(x) of FIG. 5. Note that the phase of the emf(x) relationship in each coil varies in relation to the actual position of the magnet or spacer in each coil. By using coils of width s with magnets and spacers also both of length s, adjacent coils induced emfs are 180° out of phase with each other.

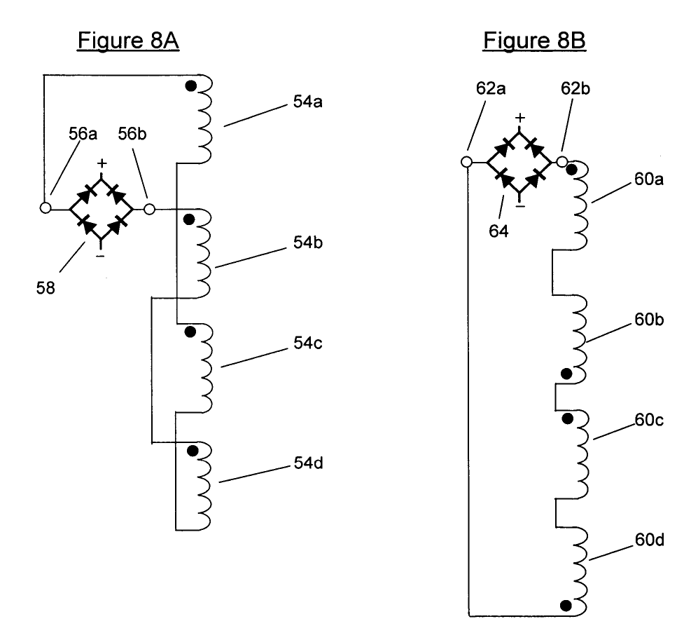

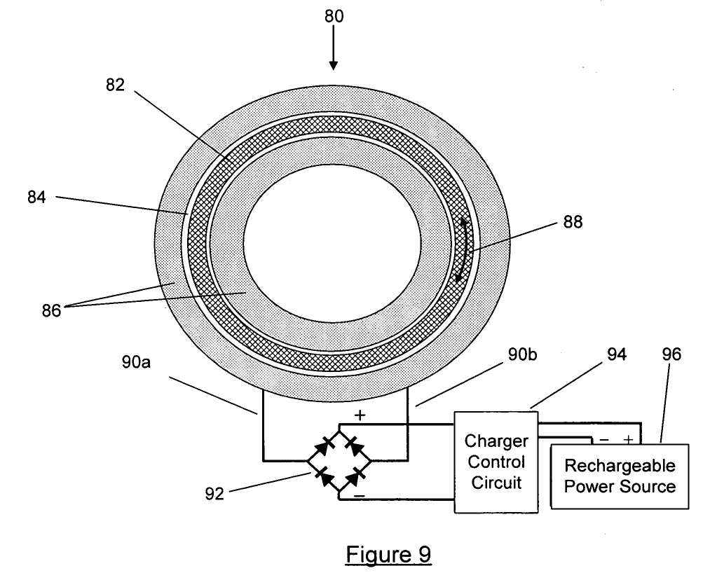

To avoid phase cancellation, the coils may be connected to output terminals 56a and 56b in the manner shown in FIG. 7. This arrangement of FIG. 7 is also shown as an electrical schematic in FIG. 8a, where the aggregate emf(x) outputs at terminals 56a,b are input to a low-forward voltage full wave diode bridge 58 to produce a varying DC output voltage.

Alternatively, as shown in the electrical schematic in FIG. 8b, each adjacent coil 60a, 60b, 60c, 60d may be wound in the opposite direction and all coils simply connected in series, with the emf output at terminals 62a,b rectified by a low-forward voltage full wave diode bridge 64 to produce a varying DC output voltage.

The peak emf(x) as seen at either terminals 36a,b or 62a,b in FIGS. 8a and 8b respectively may be estimated using Equation 6. Assume that B(x) in Equation 3 is approximately sinusoidal, so that all other bᵢ are negligible to b₁, then b₁≈B₀. In Equation 6, the peak emf will occur when the sine term is −1, and thus:

$${emf}_{Npeak} ( x ) = - \frac{π NAV}{2 s} {B}_{0} ( - 1 ) \\ {emf}_{Npeak} ( x ) = - \frac{π NAV}{2 s} {B}_{0} . \qquad Equation 7$$

Assume a 12,000 gauss NdFeB magnet 1 cm in diameter and 1 cm long moving at a velocity of 1.0 m/sec through 2 coils of length s each with N=100 turns. In MKS units:
s=1×10⁻² m A=7.87×10⁻⁵ m²
B₀=1.2 Teslas N=1×10² turns
V=1.0 m/s
Substituting in Equation 7, the peak emf will be:
emf_{Npeak}=3.14(1×10)(7.87×10⁻⁵)(1.0)(1.2)/(2×(1×10⁻²))=14.8×10⁺²⁻⁵⁺²
emf_{Npeak}=1.48 V
Using full-wave rectification as shown in FIGS. 8a or 8b, the average of a sinusoidal emf over one cycle would be approximately 0.707 times the peak emf, or 1.05 volts.

In a practical implementation, many magnets m operating inside 2 m coils wired as in FIGS. 8a or 8b would be required to produce the voltage necessary for charging a typical rechargeable battery, especially with average velocities of motion less than 1 m/sec. A linear device of the type shown in the embodiment of FIG. 6 may become long and unwieldy.

An alternate embodiment is shown in FIG. 9. A practical parasitic power collector 80 is described where a rigid ring rotor 82 has been formed using the string of m cylindrical ring magnets 32a, 32b, 32c, . . . alternating with m cylindrical spacers 34a, 34b, 34c, . . . as formed into a rigid circle. The rotor 82 floats in a sealed tube 84 containing lubricant so that the rotor may spin freely in either direction 88. The outside of tube 84 is wrapped with 2 m coils wound and connected either as in FIG. 8a or 8b form a toroidal coil assembly 86 with leads 90a and 90b to provide the aggregate output emf. When the entire parasitic power collector 80 is accelerated, the motion creates reaction forces that cause the internal rotor 82 to spin, generating an emf through Faraday's Law as described above. This direction of the emf depends on the direction of rotation, so the induced voltage across coil leads 90a,b is rectified by low-forward-voltage-drop diode bridge 92, and the varying DC voltage from 92 is input to a buck-boost DC-switching regulator and battery charger control circuit 94 to assist in charging rechargeable battery 96.

A practical rotor collection device as shown in FIG. 9 does not have to be bulky or heavy. A rotor using 25 standard NdFeB 12,000 gauss cylindrical magnets 0.375 inches in diameter and s=0.125 inches thick, with a similar 0.125 inch thick non-magnetic spacer, would have a centerline diameter of only 2.00 inches.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

### REFERENCES

[1] Joseph A. Paradiso & Thad Starner, Energy Scavenging for Mobile and Wireless Electronics, Pervasive Computing, IEEE CS, January-March 2005, pps. 18-27.
[2] Clyde Jake Kendall, Parasitic Power Collection in Shoe Mounted Devices, BS Thesis in the Department of Physics, © Massachusetts Institute of Technology, 1998.
[3] C. R. Wylie, Jr., Advanced Engineering Mathematics, Third Edition, McGraw-Hill, New York, 1966.

Applicant notes here that citation of these references is not an admission by Applicant that these references are considered prior art to the present invention.

That which is claimed:

1. A portable printer system, comprising:
a printing mechanism;
a printing and data communications controller;
a data communications system;
a rechargeable battery; and
a parasitic power collection system contributing to the charging of the battery.

2. The portable printer system of claim 1 wherein the data communications system is a wired connection to a data source.

3. The portable printer system of claim 1 wherein the data communications system is a radio.

4. The portable printer system of claim 1 wherein the data communications system is an optical data link.

5. A portable printer system, comprising:
a printing mechanism;
a printing and data communications controller;
a data storage and processing system;
a rechargeable battery; and
a parasitic power collection system contributing to the charging of the battery.

6. The portable printer system of claim 1 or claim 5 where the printer is wearable.

7. The portable printer system of claim 6 wherein the parasitic power collection system collects power from body motion.

8. The portable printer system of claim 1 or claim 5 where the printer is vehicle mounted.

9. The portable printer system of claim 8 wherein the parasitic power collection system collects power from vehicle motion.

10. The portable printer system of claim 1 or claim 5 wherein at least 10% of the average operating power used is generated by the parasitic power collection system.

11. A portable printer system, comprising:
a printing mechanism;
a rechargeable battery in communication with said printing mechanism; and
a parasitic power collection system in communication with said rechargeable battery for contributing to the charging of the battery.

12. A parasitic power collection system for providing power to a rechargeable battery located in a portable printer comprising:
a magnet string comprising:
permanent magnets; and
nonmagnetic separators spaced between said magnets; and
housing for maintaining said magnet string comprising:
a body shaped to allow said magnetic string to move in first and second directions;
a plurality of coils;
ends on said body maintaining said magnetic string in said housing; and
biasing means connected to each of said ends for biasing said magnetic string toward the center of said body,
wherein emf is generated from movement of said magnetic string relative said coils.

13. A parasitic power collection system for providing power to a rechargeable battery located in a portable printer comprising:
a magnet string comprising:
permanent magnets; and
nonmagnetic separators spaced between said magnets, wherein said magnet string is formed into a hollow cylinder; and
housing for maintaining said magnet string comprising:
a body shaped to allow said magnetic string to rotate;
a plurality of coils;
wherein emf is generated from rotation of said magnetic string relative said coils.
